(19) United States
(12) Patent Application Publication
(10) Pub. No.: US 2024/0101370 A1
(43) Pub. Date: Mar. 28, 2024

(54) Object Pickup System and Method

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/474,784

(22) Filed: Sep. 26, 2023

(30) Foreign Application Priority Data
Sep. 26, 2022 (CN) 202211174868.4

(51) Int. Cl. B65H 3/08

(52) U.S. Cl. CPC B65H 3/0816; B65H 2406/344; B65H 2553/81

(57) ABSTRACT

An object pickup system includes an object pickup device and a calculation device. The object pickup device includes a first bracket, a suction cup installed on the first bracket and adapted to be affixed to a top surface of an object, and a distance sensor installed on the first bracket and adapted to rotate with the first bracket to scan the top surface of the object. The calculation device is operatively connected to the distance sensor. The calculation device is adapted to calculate a distance from the top surface of the object to the distance sensor and a position of an edge of an opening on the top surface of the object based on the distance data collected by the distance sensor during a scanning operation.

### CROSS-REFERENCE TO RELATED APPLICATION

This application claims the benefit of Chinese Patent Application No. CN202211174868.4 filed on Sep. 26, 2022, in the State Intellectual Property Office of China, the whole disclosure of which is incorporated herein by reference.

### FIELD OF THE INVENTION

The present invention relates to an object pickup system and an object picking method.

### BACKGROUND

In the prior art, for the convenience of transportation and storage, the carrier tape used for packaging electronic products (such as connectors or chips) is usually coiled on a reel. In the prior art, a reel picking device with a vacuum suction cup is typically used to capture and transport the reel. In order to guide the reel picking device to correctly engage with the reel, a camera needs to be installed on the reel picking device for providing visual guidance for the reel picking device. At the same time, high-performance computing equipment needs to be provided, as it requires real-time processing of a large amount of image data. This results in a relatively high cost for the reel picking system as a whole.

### SUMMARY

According to an embodiment of the present disclosure, an object pickup system includes an object pickup device and a calculation device. The object pickup device includes a first bracket, a suction cup installed on the first bracket attaching to a top surface of an object, and a distance sensor installed on the first bracket and adapted to rotate with the first bracket to scan the top surface of the object. The calculation device is operatively connected to the distance sensor. The calculation device is adapted to calculate a distance from the top surface of the object to the distance sensor and a position of an edge of an opening on the top surface of the object based on the distance data collected by the distance sensor during a scanning operation.

### BRIEF DESCRIPTION OF THE DRAWINGS

The invention will now be described by way of example with reference to the accompanying Figures, of which:

FIG. 1 shows an illustrative perspective view of an object pickup device of an object pickup system and an object to be picked up according to an exemplary embodiment of the present invention;

FIG. 2 shows an illustrative perspective view of an object pickup device of an object pickup system according to an exemplary embodiment of the present invention; and

FIG. 3 shows an illustrative perspective view of a driving device and a moving device of an object pickup system according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, an object pickup system comprises an object pickup device and a calculation device. The object pickup device includes a first bracket, a suction cup installed on the first bracket and adapted to be affixed to a top surface of an object, and a distance sensor installed on the first bracket and adapted to rotate with the first bracket to scan the top surface of the object. The calculation device is communicated to the distance sensor and adapted to calculate a distance from the top surface of the object to the distance sensor and a position of an edge of an opening on the top surface of the object based on the distance data collected by the distance sensor during a scanning process.

According to another embodiment of the present disclosure, a method for picking up an object includes the steps of: 1) providing the above object pickup system; 2) moving the object pickup device above the top surface of an object to be picked up; 3) driving the object pickup device to rotate around its central axis to scan the top surface of the object through the distance sensor; and 4) calculating the distance from the top surface of the object to the distance sensor and the position of the edge of the opening on the top surface of the object based on the distance data collected by the distance sensor during the scanning process.

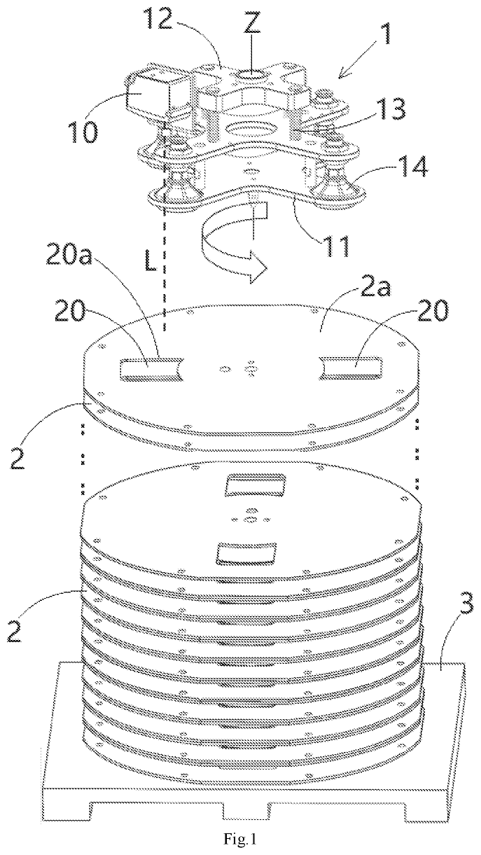

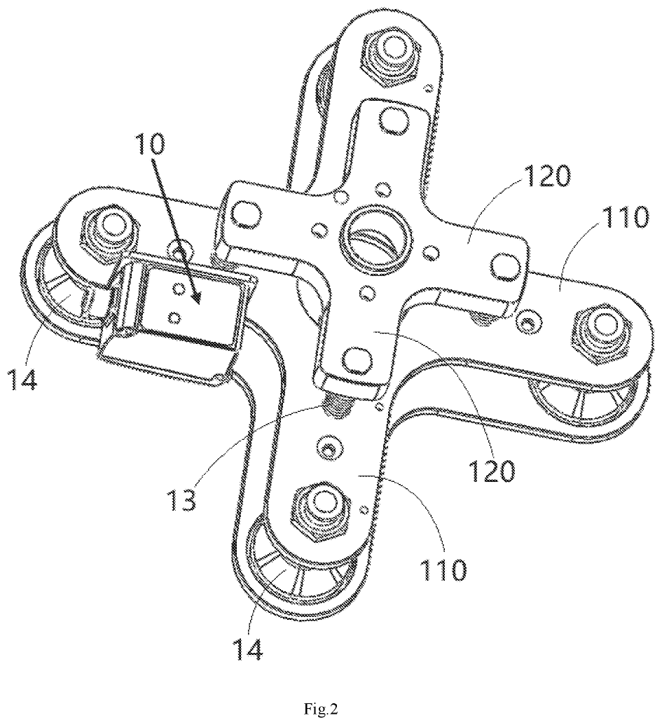

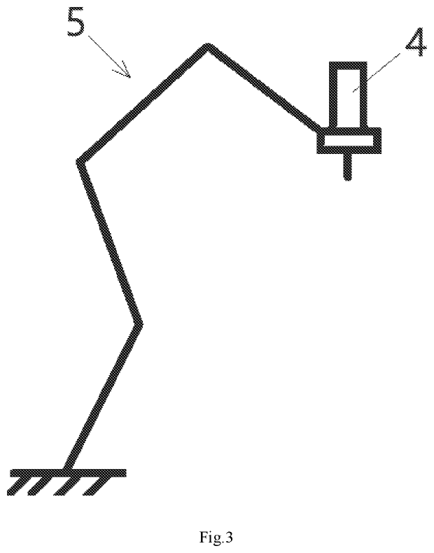

FIG. 1 is an illustrative perspective view of an object pickup device 1 of an object pickup system and an object 2 to be picked up according to an exemplary embodiment of the present invention. FIG. 2 is an illustrative perspective view of the object pickup device 1 of the object pickup system according to an exemplary embodiment of the present invention. FIG. 3 is an illustrative perspective view of the driving device 4 and the moving device 5 of the object pickup system according to an exemplary embodiment of the present invention.

As shown in FIGS. 1-3, in an exemplary embodiment of the present invention, an object pickup system is disclosed. The object pickup system includes the object pickup device 1 and a calculation device (10). The object pickup device 1 includes: a first bracket 11, a suction cup 14, and a distance sensor 10. The calculation device may be integrated into the distance sensor 10. Thus, the distance sensor 10 is also representative of the calculation device. The suction cup 14 is installed on the first bracket 11 for adsorption on the top surface 2a of object 2. The distance sensor 10 is installed on the first bracket 11 and adapted to rotate with the first bracket 11 to scan the top surface 2a of object 2. The calculation device is operatively connected to the distance sensor 10 and is adapted to calculate the distance from the top surface 2a of object 2 to the distance sensor 10 and the position of the edge 20a of the opening 20 on the top surface 2a of object 2 based on the distance data collected by the distance sensor during the scanning process. In an exemplary embodiment of the present invention, the calculation device may be a functional module composed of software and hardware running on a computer, and in particular a processor and a memory device forming part of the distance sensor 10. The memory device stores instructions that, when executed by the processor, perform the function of the calculation device described herein.

A plurality of objects 2 to be picked up are stacked on the base 3. The distance sensor 10 scans the top surface 2a of the top object 2 in the plurality of stacked objects 2 to obtain the distance from the top surface 2a of the top object 2 to the distance sensor 10 and the position of the edge 20a of the opening 20 on the top object 2. In the illustrated embodiment, the object 2 is in a disc shape, with a top surface 2a, a bottom surface, and a peripheral surface. For example, the aforementioned object 2 can be a reel used for winding a carrier tape. Electronic products (such as connectors or chips) are packaged in carrier tape, and the carrier tape is wound on the reel. This can facilitate the transportation and storage of electronic products. In the illustrated embodiments, the distance data collected by the distance sensor 10 undergoes a step change at the edge 20a of the opening 20. The calculation device identifies and calculates the position of the edge 20a of the opening 20 based on the step change of the distance data collected by the distance sensor 10.

The object pickup system further includes a driving device 4. The driving device 4 is connected to the object pickup device 1 and is adapted to drive the first bracket 11 to rotate. When the distance sensor 10 scans the top surface 2a of object 2, the driving device 4 drives the first bracket 11 to rotate around the axis Z that coincides or is parallel to the central axis of object.

The driving device 4 is also adapted to rotate the suction cup 14 to an avoidance position that avoids the opening 20 on the object 2 based on the calculated position of the edge 20a of the opening 20, in order to prevent the suction cup 14 from adsorbing onto the opening 20. In the illustrated embodiment, when the suction cup 14 is rotated to the avoidance position, the projection of the suction cup 14 and the opening 20 in the axial direction of the object pickup device 1 does not overlap. This ensures that the suction cup 14 will not adsorb onto the opening 20.

The object pickup system further includes a moving device 5. This moving device 5 is adapted to move the object pickup device 1 to a scanning position above the object 2, in order to scan the top surface 2a of object 2 through distance sensor 10. In the illustrated embodiment, when the object pickup device 1 is moved to the scanning position, the central axis of the object pickup device 1 coincides or is parallel to the central axis of the object 2. The aforementioned moving device 5 is also adapted to move the object pickup device 1 from the scanning position to an adsorption position based on the calculated distance from the top surface 2a of object 2 to the distance sensor 10. In the illustrated embodiment, when the object pickup device 1 is moved to the adsorption position, the suction cup 14 is adsorbed on the top surface 2a of the object 2.

The moving device 5 can include a multi degree of freedom robot or a multi degree of freedom robotic arm under computer control (e.g., under control of the processor of the calculation device), and the driving device 4 can include a motor installed on the moving device 5. The illustrated output shaft of the motor is connected to the object pickup device 1 to drive the object pickup device 1 to rotate around its central axis. The distance sensor 10 is a laser distance sensor. The laser distance sensor emits a laser beam L towards the top surface 2a of object 2 and scans the top surface 2a of object 2 with the laser beam L.

The object pickup device 1 further includes a second bracket 12, a connecting rod, and a spring 13. The connecting rod is connected between the first bracket 11 and the second bracket 12 and allows the first bracket 11 to move relative to the second bracket 12 along the axial direction of the object pickup device 1. The spring 13 is installed on the connecting rod and compressed between the first bracket 11 and the second bracket 12. In this way, the first bracket 11 can float along the axial direction of the object pickup device 1 relative to the second bracket 12.

In an exemplary embodiment of the present invention, one end of the connecting rod can be slidably assembled into the assembly hole on the first bracket 11, and the other end can be fixedly connected to the second bracket 12. In this way, it is possible to allow the first bracket 11 to move along the axial direction of the object pickup device 1 relative to the second bracket 12. The driving device 4 (e.g., its output shaft) is also connected to the second bracket 12 for driving the object pickup device 1 to rotate around the central axis of the object pickup device 1.

The first bracket 11 includes a plurality of first arms 110, which are evenly spaced in the circumferential direction of the object pickup device 1. The object pickup device 1 includes a plurality of suction cups 14, which are respectively installed on the ends of the plurality of first arms 110. The distance sensor 10 is installed on one of the plurality of first arms 110.

The second bracket 12 includes a plurality of second arms 120 corresponding to the plurality of first arms 110. The plurality of second arms 120 are evenly spaced in the circumferential direction of the object pickup device 1. The object pickup device 1 includes a plurality of connecting rods, one ends of which are respectively slidably assembled into the assembly holes on the first arm 110, and the other ends are respectively fixedly connected to the plurality of second arms 120. The object pickup device 1 includes a plurality of springs 13, which are respectively installed on the plurality of connecting rods and compressed between the first arm 110 and the second arm 120. The first bracket 11 includes four first arms 110, such that the first bracket 1 is in a cross shape. Similarly, the second bracket 12 includes four second arms 120, so that the second bracket is in a cross shape.

In another exemplary embodiment of the present invention, the object pickup device 1 may include a plurality of distance sensors, which are spaced in the circumferential direction of the object pickup device 1, and the distances between the plurality of distance sensors and the central axis of the object pickup device 1 are different from each other. In this way, the plurality of distance sensors can be used to simultaneously scan the top surface 2a of object 2 with different scanning radii, which can increase the distance data detected during scanning and more accurately identify the position of the opening 20 on object 2.

As shown in FIGS. 1 to 3, in another exemplary embodiment of the present invention, a method for picking up objects is also disclosed. The method of picking up object mainly includes the following steps of:
S10: Providing the aforementioned object pickup system;
S20: As shown in FIG. 1, moving the object pickup device 1 above the top surface 2a of the object 2 to be picked;
S30: As shown in FIG. 1, driving the object pickup device 1 to rotate around its central axis to scan the top surface 2a of object 2 using distance sensor 10;
S40: Calculating the distance from the top surface 2a of object 2 to the distance sensor 10 and the position of the edge 20a of the opening 20 on the top surface 2a of object 2 based on the distance data collected by distance sensor 10 during the scanning process.

As shown in FIGS. 1-3, in the illustrated embodiment, the aforementioned object picking method further includes steps of:
S50: based on the calculated position of the edge 20a of the opening 20, determining whether the projection of the suction cup 14 and the opening 20 of object 2 in the axial direction of the object pickup device 1 overlaps. If the judgment result is yes, execute step S60 below; otherwise, execute step S70 below;
S60: Driving the object pickup device 1 to rotate the suction cup 14 to the avoidance position to avoid the opening 20, so that the projection of the suction cup 14 and the opening 20 in the axial direction of the object pickup device 1 does not overlap;
S70: Moving the object pickup device 1 along the axial direction of the object pickup device 1 to the adsorption position and adsorb and pick up the object 2 through the suction cup 14.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An object pickup system, comprising:
an object pickup device, including:
a first bracket;
a suction cup arranged on the first bracket and adapted to be affixed to a top surface of an object to be picked up; and
a distance sensor arranged on the first bracket and adapted to rotate with the first bracket to scan the top surface of the object; and
a calculation device operatively connected to the distance sensor and adapted to calculate a distance from the top surface of the object to the distance sensor and a position of an edge of an opening on the top surface of the object based on the distance data collected by the distance sensor as the top surface is scanned.

2. The object pickup system according to claim 1, wherein the distance data collected by the distance sensor undergoes a step change at the edge of the opening, and the calculation device identifies and calculates the position of the edge of the opening based on the step change of the distance data collected by the distance sensor.

3. The object pickup system according to claim 1, further comprising a driving device connected to the object pickup device and adapted to drive the first bracket to rotate, wherein when the distance sensor scans the top surface of the object, the driving device drives the first bracket to rotate around a rotation axis that coincides or is parallel to a central axis of the object.

4. The object pickup system according to claim 3, wherein the driving device is adapted to rotate the suction cup to an avoidance position that avoids the opening based on the calculated position of the edge of the opening.

5. The object pickup system according to claim 4, wherein when the suction cup is rotated to the avoidance position, a projection of the suction cup and the opening in an axial direction of the object pickup device do not overlap.

6. The object pickup system according to claim 3, further comprising a moving device adapted to move the object pickup device to a scanning position above the object to scan the top surface of the object through the distance sensor, when the object pickup device is moved to the scanning position, a central axis of the object pickup device coincides or is parallel to the central axis of the object.

7. The object pickup system according to claim 6, wherein the moving device is further adapted to move the object pickup device from the scanning position to an adsorption position based on the calculated distance from the top surface of the object to the distance sensor.

8. The object pickup system according to claim 7, wherein when the object pickup device is moved to the adsorption position, the suction cup is affixed to the top surface of the object.

9. The object pickup system according to claim 6, wherein:
the moving device includes a multi degree of freedom robot or robotic arm;
the driving device includes a motor installed on the moving device; and
an output shaft of the motor is connected to the object pickup device to drive the object pickup device to rotate around its central axis.

10. The object pickup system according to claim 1, wherein the distance sensor is a laser distance sensor emitting a laser beam towards the top surface of the object and scans the top surface of the object with the laser beam.

11. The object pickup system according to claim 1, wherein the object pickup device further includes:
a second bracket;
a connecting rod connected between the first bracket and the second bracket and adapted to enable the first bracket to move axially relative to the second bracket along the axial direction of the object pickup device; and
a spring arranged on the connecting rod and compressed between the first bracket and the second bracket such that the first bracket is floatable along the axial direction of the object pickup device relative to the second bracket, wherein the object pickup system further includes a driving device connected to the second bracket and adapted to drive the object pickup device to rotate around the central axis of the object pickup device.

12. The object pickup system according to claim 11, wherein a first end of the connecting rod is slidably assembled into an assembly hole on the first bracket, and a second end is fixedly connected to the second bracket enabling the first bracket to move relative to the second bracket along the axial direction of the object pickup device.

13. The object pickup system according to claim 11, wherein:
the first bracket includes a plurality of first arms evenly spaced in the circumferential direction of the object pickup device; and
the object pickup device includes a plurality of suction cups installed on the respective ends of the plurality of first arms.

14. The object pickup system according to claim 13, wherein the distance sensor is installed on one of the plurality of first arms.

15. The object pickup system according to claim 13, wherein:
the second bracket includes a plurality of second arms corresponding to the plurality of first arms, the plurality of second arms are evenly spaced in the circumferential direction of the object pickup device; and
the object pickup device includes a plurality of connecting rods having first ends respectively slidably assembled into the assembly holes on the first arms, and second ends respectively fixedly connected to the plurality of second arms.

16. The object pickup system according to claim 15, wherein the object pickup device includes a plurality of springs arranged on respective ones of the plurality of connecting rods and compressed between the first arm and the second arm.

17. The object pickup system according to claim 16, wherein the first bracket includes four first arms arranged in a cross-shape, and the second bracket includes four second arms arranged in a cross-shape.

18. The object pickup system according to claim 1, wherein the object pickup device includes a plurality of distance sensors spaced in a circumferential direction of the object pickup device, wherein distances between the plurality of distance sensors and a central axis of the object pickup device are different from one another.

19. A method for picking up an object, comprising:
providing the object pickup system, having:
a driving device;
an object pickup device, including:
a first bracket;
a suction cup arranged on the first bracket and adapted to be affixed to a top surface of an object; and
a distance sensor arranged on the first bracket and adapted to rotate with the first bracket to scan the top surface of the object; and
a calculation device operatively connected to the distance sensor;
moving the object pickup device above the top surface of an object to be picked up;
with the driving device, driving the object pickup device to rotate around its central axis to scan the top surface of the object through the distance sensor; and
with the calculation device, calculating a distance from the top surface of the object to the distance sensor and the position of an edge of an opening on the top surface of the object based on the distance data collected by the distance sensor during the scanning process.

20. The method according to claim 19, further comprising steps of, based on the calculated position of the edge of the opening:
determining whether the projection of the suction cup and the opening of the object in the axial direction of the object pickup device overlap; and
if the suction cup and the opening of the object in the axial direction of the object pickup device overlap, driving the object pickup device to rotate the suction cup to an avoidance position that avoids the opening, such that a projection of the suction cup and the opening in the axial direction of the object pickup device do not overlap; or
if the suction cup and the opening of the object in the axial direction of the object pickup device do not overlap, moving the object pickup device along the axial direction of the object pickup device to an adsorption position and affix and pick up the object via the suction cup.
